(19) United States
(12) Patent Application Publication
(10) Pub. No.: US 2025/0070298 A1
(43) Pub. Date: Feb. 27, 2025

(54) BATTERY CELL ARRANGEMENT

(71) Applicant: Expion360, Inc., Redmond, OR (US)

(72) Inventors: Zhicheng Xu, Redmond, OR (US); Paul Shoun, Redmond, OR (US); Jared Withrow, Redmond, OR (US); Chaofan Zhu, Redmond, OR (US); Yongbin Zhao, Redmond, OR (US); Hua Zhou, Redmond, OR (US)

(21) Appl. No.: 18/386,331

(22) Filed: Nov. 2, 2023

Related U.S. Application Data
(63) Continuation-in-part of application No. 18/238,100, filed on Aug. 25, 2023.
(63) Continuation-in-part of application No. 18/238,175, filed on Aug. 25, 2023.

(51) Int. Cl. H01M 10/615; H01M 10/48; H01M 10/633; H01M 10/643; H01M 10/6561; H01M 10/6571; H01M 50/213; H02J 7/00

(52) U.S. Cl. CPC H01M 10/615; H01M 10/482; H01M 10/633; H01M 10/643; H01M 10/6561; H01M 10/6571; H01M 50/213; H02J 7/0047

(57) ABSTRACT

A battery arrangement is provided, including a battery arrangement comprising a plurality of generally cylindrical battery cells positioned side by side in a planar array, the plurality of generally cylindrical battery cells comprising at least 16 generally cylindrical battery cells and a battery thermal management system (BTMS) configured to evaluate switch conditions, temperature, and available equipment to effectuate a heating regimen for heating the generally cylindrical battery cells. The plurality of generally cylindrical battery cells is connected to provide electric power over a single electrical power transmission channel.

The present application is a continuation-in-part of U.S. patent application Ser. No. 18/238,175, filed Aug. 25, 2023, entitled “Battery Cell Arrangement,” inventors Zhicheng Xu, et al., and a continuation-in-part of U.S. patent application Ser. No. 18/238,100, filed Aug. 25, 2023, entitled “Battery Arrangement,” inventors Zhicheng Xu, et al., the entirety of both of which are incorporated herein by reference.

### BACKGROUND

### I. Field

The present invention relates generally to batteries, and more specifically to control and operation of battery cases and battery packs comprising battery cells.

### II. Description of the Related Art

Relatively large scale battery packs including Lithium Ion (Li-ion) batteries employed in electric vehicles (EVs) typically include a battery case, a battery, a battery management system (BMS) and accessories. Heat is a primary concern for such large scale battery packs, as excessive heat can cause wear on battery components, and the operating temperature window for Li-ion batteries is critical for overall safety. The temperature range for charging Li-ion batteries is typically from 0° C. to 60° C. and for discharge from −20° C. to 60° C.

Developments in the past in this area have focused on battery cooling. EV batteries have dedicated liquid or phase change battery thermal management systems (BTMS) seeking to cool battery components. In light electric vehicles (LEVs), even and relatively efficient heating of the cells in the battery pack of such vehicles is beneficial, particularly when the battery pack is exposed to lower temperatures. Low charge/discharge rates in batteries tend to result in less heat generation, which can be problematic particularly in low temperature conditions. Battery temperature control and a BTMS that can heat the battery provides advantages when charging the battery at lower temperatures.

The cost of implementing technologies used in EV BTMS applications, such as liquid phase change, is significant and such an implementation is complicated if not in many cases impossible. Light electric vehicles require safely heating the battery pack, evenly heating the battery pack, heating individual cells in the battery pack evenly, efficiently heating the battery pack, and providing a low cost and easy manufacturing solution.

Control of such devices can be challenging in certain instances. Appropriate thermal performance in a multiple cell arrangement, for example, requires excellent control and is not typically available.

It would be beneficial to provide a battery heating arrangement for smaller LEV and auxiliary battery applications that overcomes issues with prior designs.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

According to one embodiment, there is provided a battery arrangement comprising a plurality of generally cylindrical battery cells positioned side by side in a planar array, the plurality of generally cylindrical battery cells comprising at least 16 generally cylindrical battery cells and a battery thermal management system (BTMS) configured to evaluate switch conditions, temperature, and available equipment to effectuate a heating regimen for heating the generally cylindrical battery cells. The plurality of generally cylindrical battery cells is connected to provide electric power over a single electrical power transmission channel.

According to a further embodiment, there is provided a battery arrangement comprising a co-planar array of a plurality of substantially cylindrical battery cells in a single planar layer without a second planar layer of substantially cylindrical battery cells, wherein the plurality of substantially cylindrical battery cells comprises at least 16 substantially cylindrical battery cells, and a battery thermal management system (BTMS) configured to evaluate switch conditions, temperature, and available equipment to effectuate a heating regimen for heating the plurality of substantially cylindrical battery cells. The plurality of substantially cylindrical battery cells provides electric power over a single electrical power transmission channel.

According to another embodiment, there is provided a battery arrangement comprising a plurality of not less than sixteen substantially cylindrical battery cells arranged in a planar side by side orientation and a battery thermal management system (BTMS) configured to evaluate switch conditions, temperature, and available equipment to effectuate a heating regimen for heating the plurality of substantially cylindrical battery cells. The plurality of substantially cylindrical battery cells provides electric power over a single electrical power transmission channel.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a 32 cell arrangement employing individually wrapped cells;

FIG. 2 illustrates a 32 cell arrangement having an S-shaped snake-like PTCHF layer provided;

FIG. 3 shows an alternate S-shaped snake-like PTCHF layer about the 32 cell embodiment;

FIG. 4 is a 32 cell arrangement having an encircling PTCHF layer;

FIG. 5 is a cell arrangement with PTCHF layers on top and bottom of the cells;

FIG. 6 is a view of the battery exterior according to one embodiment of the present design;

FIG. 7 is a general representation of components employed in one embodiment of the present design;

FIG. 8 is a cross section of a “jellyroll” arrangement of a battery cell that may be employed with the present design;

FIG. 9 illustrates a cross section of an embodiment similar to FIG. 5 including components contained therein; and

FIG. 10 is a representation of an embodiment of the design showing the various cells, the top PTCHF layer, and related components;

FIG. 11 shows a mounting bracket enabling the mounting of battery packs on a wall or ceiling;

FIG. 12 is a general depiction of the battery pack, BMS, and BTMS of the present design; and

FIG. 13 is a flow chart depicting the functional operation of the control of the present battery design.

### DETAILED DESCRIPTION

In this document, the words “embodiment,” “variant,” and similar expressions are used to refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar phrases are used to indicate one of a number of different possible embodiments. The number of possible embodiments is not necessarily limited to two or any other quantity.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make or use the invention, and not to limit the scope of legal protection afforded the invention, which is defined by the claims and their equivalents.

As used herein, the term “battery” refers to at least one and potentially multiple cells connected in a series and/or parallel arrangement. A “cell” or “battery cell” is a device that is a source of electrical energy produced by chemical energy that includes electrodes, electrolytes, a separator, and has an external container with terminals attached. The term “battery pack” means batteries provided in an enclosure that may or may not include protective devices, cooling systems, monitoring electronics, and so forth. Battery packs may be employed in a battery system and may include external circuitry and controls elements such as cooling devices or protective devices.

The present design may include a battery, battery case, battery pack, battery management system (BMS), and accessories such as heating elements forming a battery thermal management system (BTMS).

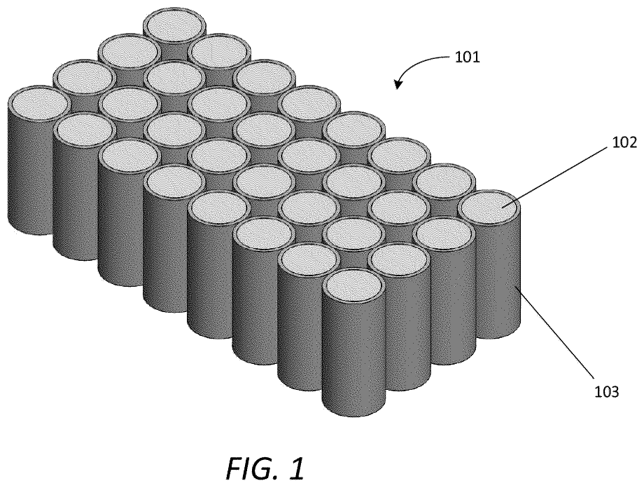

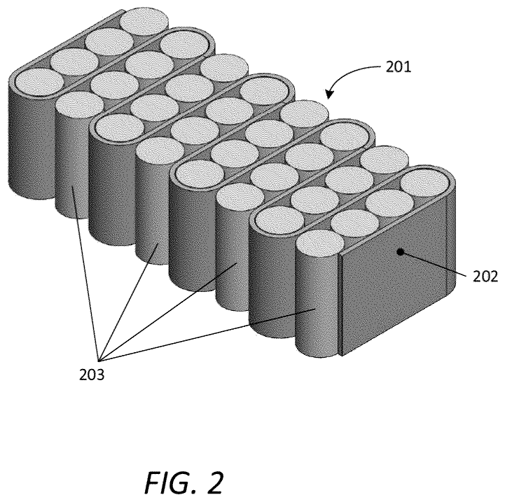

FIG. 1 illustrates a side view of a first embodiment of the overall design. From FIG. 1, cell 102 is provided within battery pack 101. Each cell of the 32 cells in this embodiment is covered by a layer 103 of PTC heating film (PTCHF). In all views showing cells, more or fewer cells may be employed. FIG. 2 illustrates a similar 32 cell embodiment 201, in this arrangement including PTCHF layer 202 in a sort of “S” pattern snaking its way through the rows of four cells. Cells 203 are cells exposed in this view that are not covered by the “S” pattern. The other cells in this viewable row are covered by PTCHF layer 202. Any number of cells may be provided, including in one embodiment 16 cells.

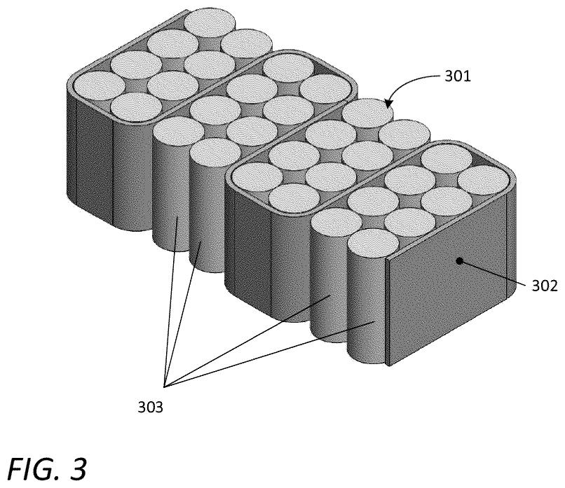

FIG. 3 shows an alternate embodiment 301 again including 32 cells. In FIG. 3, the PTCHF layer 302 is again in a snake-like “S” pattern but passes around two columns of cells rather than the one column in FIG. 2. Cells 303 are exposed in this view, while the other cells in the viewable row are covered by PTCHF layer 302.

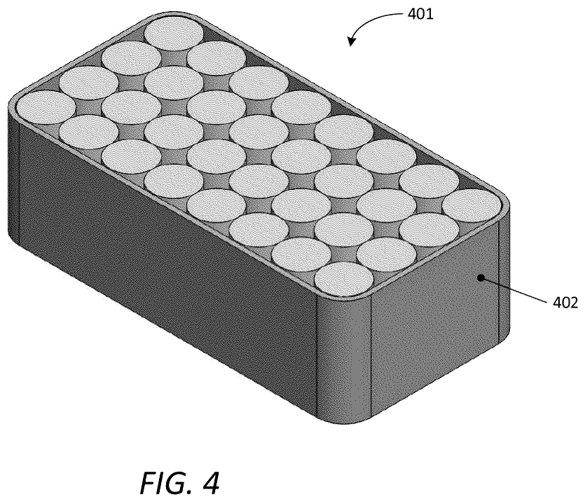

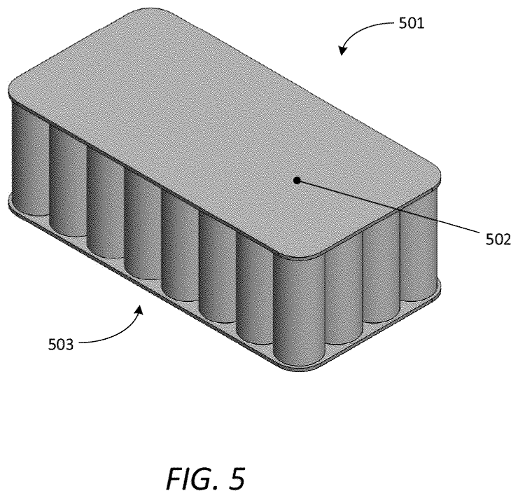

FIG. 4 illustrates an embodiment of an arrangement 401 again including 32 cells with PTCHF layer 402 encircling all 32 cells. FIG. 5 illustrates an embodiment of an arrangement 501 wherein the array of cells is covered on top and bottom by PTCHF layers 502 and 503. As discussed below, certain efficiencies and benefits may be available with the arrangement of FIG. 5.

In general, a battery pack according to the present design includes multiple bricks connected in series. A brick consists of several cells connected in parallel according to one embodiment, such as in the configurations presented in FIGS. 1 through 5. In certain configurations, and depending on the chemistry of the cells, four bricks may be employed to produce a 12V battery, eight bricks for a 24V battery, twelve bricks for a 36V battery, and sixteen bricks for a 48V battery, and so forth.

Busbars or cables have traditionally been employed for connecting bricks in series. In the present design, the structures and polarity of each brick are orientated to achieve a single layer design for desired configurations, including 12V, 24V, and 48V battery pack configurations. No cable pack is required in the current design, including the design presented in FIG. 5. Omission of connection points on each brick improves the structural rigidity of the resultant design. Contact resistance on connection points and resistance on cables are eliminated.

For the situations illustrated in FIGS. 3, 4, and 5, the cell surfaces do not contact PTCHF. The cells heat up via thermal radiation through the air gap and thermal convection at the cell's surface. This creates a high-temperature difference between the surface contacting PTCHF and the surface not contacting PTCHF.

One target in the LEV/auxiliary battery area is to provide an ability to heat the battery pack from −20° C. to 10° C. in one hour. A high-temperature gradient in the cell means uneven internal resistance, which can lead to regional hot spots. Heating the battery pack efficiently can be addressed via the PTCHF power source. If the battery is not connected to power sources, the battery pack powers the PTCHF to heat the battery pack from −20° C. to above 0° C. such that the battery can be charged once the power source is available. For an off-grid system, the battery temperature can cool down at night. The battery pack via the BTMS powers the PTCHF to heat the battery pack above 0° C. If a solar charging system is provided, the solar charging system can charge the battery once the sun rises. If the battery is connected to power sources or the battery pack temperature is too low to be discharged, the BTMS controls the power source to power the PTCHF to heat the battery pack above 0° C. and the power source starts charging the battery.

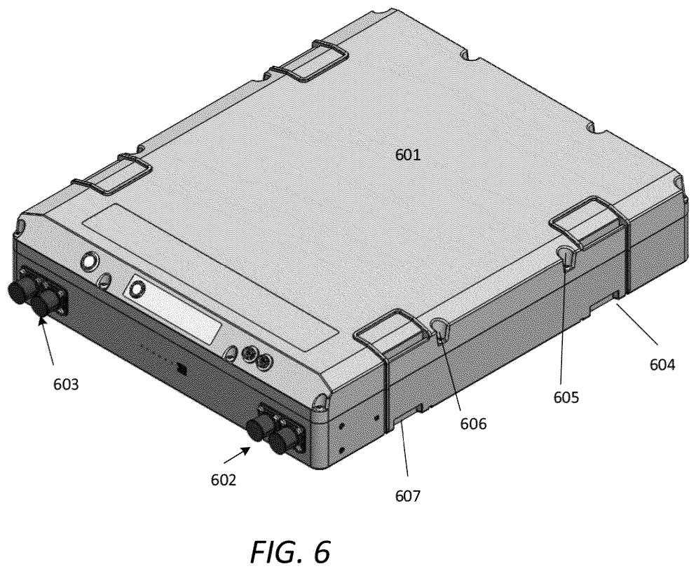

When assembled and provided with an exterior case, the battery pack may be as shown in FIG. 6. The battery case 601 may have thread inserts on both sides. Thread inserts work with rack mount brackets to secure the battery on a server rack and the battery case may include slots for the mounting system. The battery case in one embodiment has an external structure rib. The slots and external rib work limit horizontal movement when stacked together.

The single layer design of the battery pack enables part of the structure to bear the load in the vertical direction and achieve a stackable installation. In one embodiment, the internal structure rib on the top and bottom of the case directly contacts the battery or brick.

Terminals 602 and 603 on battery case 601 may include dual connection points, reducing contact resistance and eliminating the risk of an unbalanced battery in a battery bank. The battery case 601 may also have slots, such as slots 604-607, on both the left and right sides. A terminal cover may be employed that clips into one or more slots to cover the terminal or terminals. A groove (not shown) may be provided on the battery case top and a tongue on the battery case bottom to facilitate connection of the battery case top to the battery case bottom. A seal ring (not shown) may be provided between the battery case top and the battery case bottom, reducing risk of water being trapped in the groove, as a typical installation of the design of FIG. 6 is in the upright position. Screw holes may be located outside of the seal ring to improve waterproof rating.

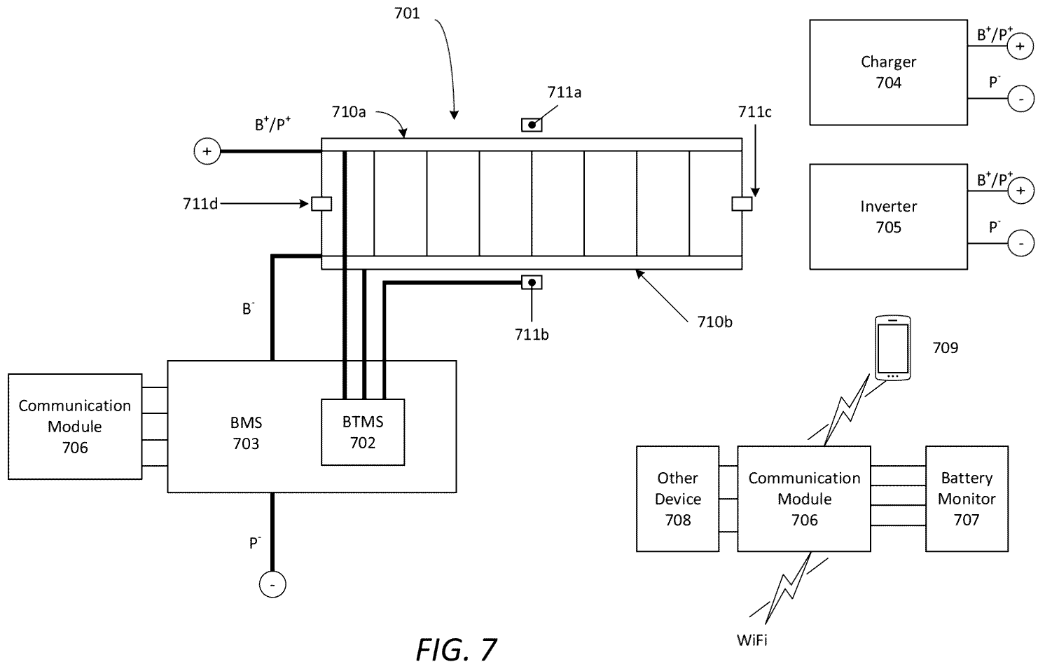

The entire battery system of the present design may include several batteries and power electronic devices, such as a battery monitor, charger, and inverter. In the present design, a cooling fan can be installed between each battery. FIG. 7 illustrates a conceptual representation of the entire battery system, including battery 701 comprising multiple cells, BTMS 702 within BMS 703, charger 704, and inverter 705. BMS 703 receives battery pack negative voltage and data is provided to control signals received from communication module 706. Battery negative is provided from BMS 703 to battery 701. Battery pack positive, or battery positive, is provided to battery 701. An epoxy insulator may be provided with battery 701.

BTMS 702 may include the BMS control functionality and devices such as thermal sensors and heating film. Communication module is shown connected to battery monitor 707 and may be connected to “other device” 708, which may represent charger 704 or inverter 705, or alternately a network, such as an RV or marine boat network. Communication module 706 may receive signals from a remote device 709 such as a smartphone or via an available communication protocol such as Wifi or Bluetooth.

The BTMS 702 employs layers of a heating film, here PTCHF 710a and 710b, representing the top and bottom PTCHF implementation of FIG. 5. Note that in some implementations, an epoxy insulator or other intervening layer may be provided between PTCHF layers 710a and 710b and the cells. Not shown in this view are various switches, such as at least one of a temperature regulated switch, a manual switch, and a software controlled switch. When the manual switch is on, the software controlled switch enables the user to remotely program a heating schedule based on the anticipated operating environment using, for example, remote device 709. For example, the battery environment temperature may be expected to drop below 0° C. between 10 pm and 6 am. The BTMS 702 may operate to heat the battery 701 from 9 pm to 7 am. The manual switch 708 provides a hard shutoff in case the ambient temperature becomes relatively high or the battery system is being stored to preserve energy and battery cycle life.

The temperature regulated switch, typically provided on BMS 703, may poll four temperature sensors 711a-d located on the center, edge, top, and bottom of the battery pack. The temperature regulated switch 707 shuts off the BTMS 702 once a desired battery pack temperature is achieved regardless of whether the manual or software switch is on or off.

PTCHF increases in resistance as temperature increases, providing a positive temperature coefficient. As resistance increases, power decreases and prevents the battery pack from overheating even if other safeties fail. At low temperatures, the PTCHF may provide increased power and heat the battery pack at a higher rate.

Thermal conduction provides heat without need for a liquid/phase change heat exchanger. Relatively even heating provides for each cell to be in the same temperature range.

The BTMS 702 of the present design provides an ability for different versions of the battery to be employed and controlled via a single unified system. The present design employs a uniform communication protocol between each battery. In operation, the BTMS employs a battery monitor 703, shown in FIG. 7 externally from BTMS 702, connected to the battery system that collects information from each battery, such as voltage, current, power, state of charge, temperature, warning, and so forth. The battery monitor 703 in one embodiment may display battery information on a screen. Each battery may employ Bluetooth communication as standard and the BTMS and/or monitor may communicate via Bluetooth or any other communication medium appropriate for the application. While battery monitor 703 is shown as external to BTMS 702, the two may be provided together or integrally or may be separate.

The standard charge/discharge rate of one embodiment of the battery of the present design is approximately 1C. The present BTMS focuses on heating rather than cooling, as lithium-ion cells can be damaged if charged below freezing.

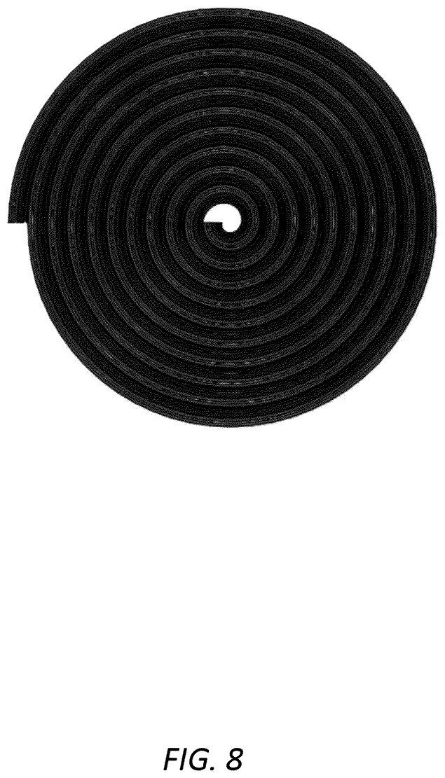

With respect to the individual cells provided, construction of a cylindrical cell may include multiple layers of materials. FIG. 8 shows one such construction, called a “jellyroll” or a “Swiss roll,” including a separator layer (non-conductive/plastic), anode layer (copper foil and coating), and a cathode layer (aluminum foil and coating). These layers are rolled to form a cylindrical shape, which may be inserted into a cell case and filled with electrolytes.

Copper and aluminum provide relatively high thermal conductivity (on the order of 100+ W/m K). The separator, electrolyte, and cathode/anode coating exhibit relatively low thermal conductivity, on the order of approximately 1 W/m K. On the vertical plane cross-section of a cell, the thermal conductivity in-plane (parallel to the cross-section) is approximately 10× to 100× higher than through-plane (perpendicular to the cross-section) depending on the shape and/or chemistry of the cell.

The thermal characteristics in a battery pack are thermal convection and thermal radiation from one cell to another cell. Convection occurs on the circular surface of a cell, radiation and convection ensues via air gaps between cells, and convection takes place on the circular surface of an adjacent cell. As a result, BTMS 702 warms the battery pack, such as from a low temperature to above freezing. Such heating facilitates safe charging in cold environments.

One embodiment of an individual cylindrical cell may have a dimension of 26 mm in diameter and 65 mm in height. For each such cylindrical cell, thermal conduction in vertical direction can heat a cell more uniformly and efficiently compared to thermal conduction in radial directions. The height of the cell is three times the diameter and thermal conductivity in-plane is on the order of 10×-100× higher than through-plane. Heating films can be deployed in the vertical direction on the battery to convert the non-heated battery pack to a heated battery pack.

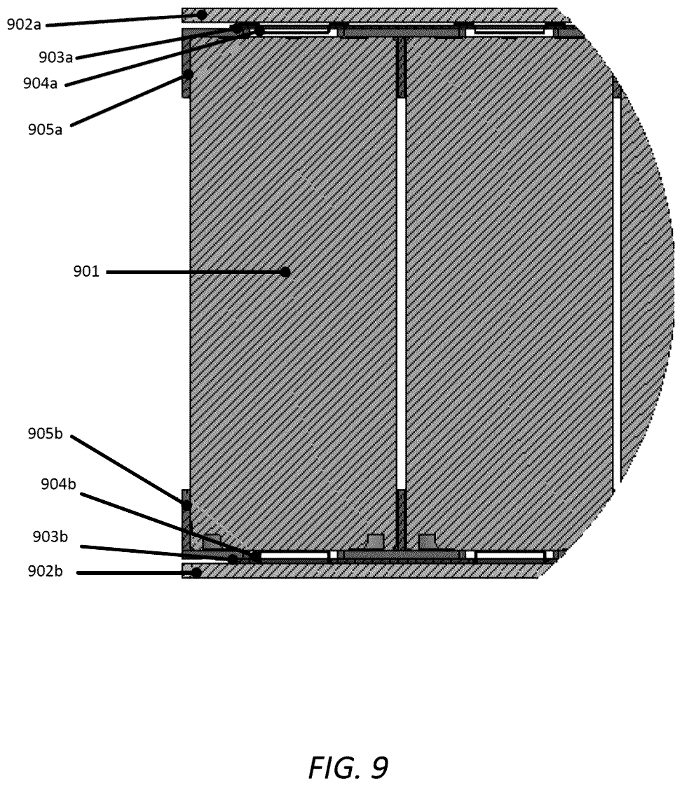

FIG. 9 illustrates a cross section side view of a battery arrangement in accordance with FIG. 5. FIG. 9 shows cell 901, cell brackets 905a and 905b, nickel plates 904a and 904b, nickel plated copper collectors 903a and 903b, and epoxy boards 902a and 902b. The heating film, such as PTCHF, is not shown in this view but is provided outside epoxy boards 902a and 902b. The epoxy board 902a contacts the nickel plated copper collector 903a which in turn contacts nickel plates 904a which contacts cell 901. As may be seen in FIG. 9, pairs of several components are provided and similar contacts are provided for both lower and upper portions of the battery arrangement.

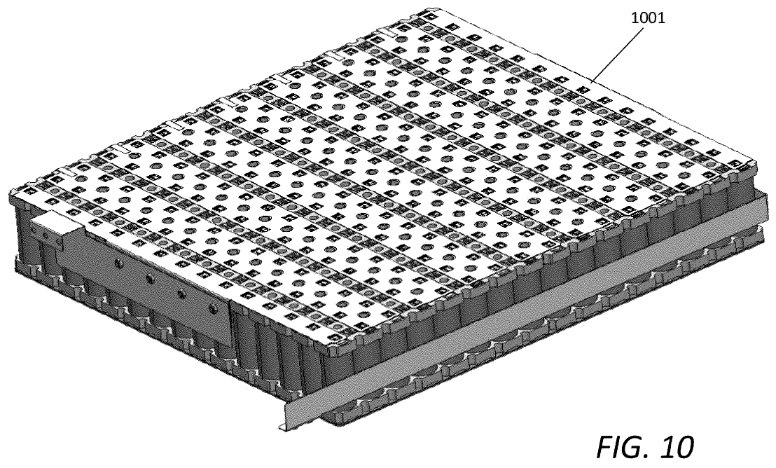

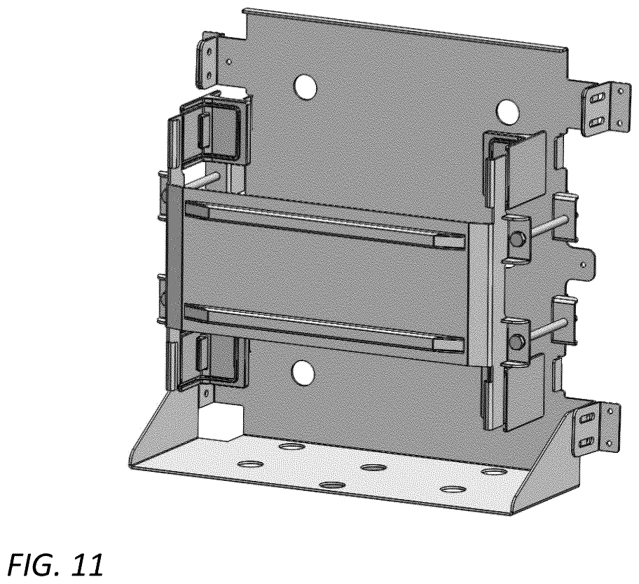

FIG. 10 illustrates an embodiment of the complete design in a 15 by 16 cell arrangement. Nickel plated copper collector 1001 is similar to nickel plated copper collector 903. The PTCHF and epoxy board are not shown in FIG. 10. In practice, an epoxy board may be placed on top of nickel plated copper collector 1001, and the PTCHF layer may be positioned on top of the epoxy board. FIG. 11 illustrates a bracket usable to mount a battery pack including outer case, or multiple such battery packs, to either a wall or a ceiling, i.e., suspending the battery pack or packs from an upper interior surface.

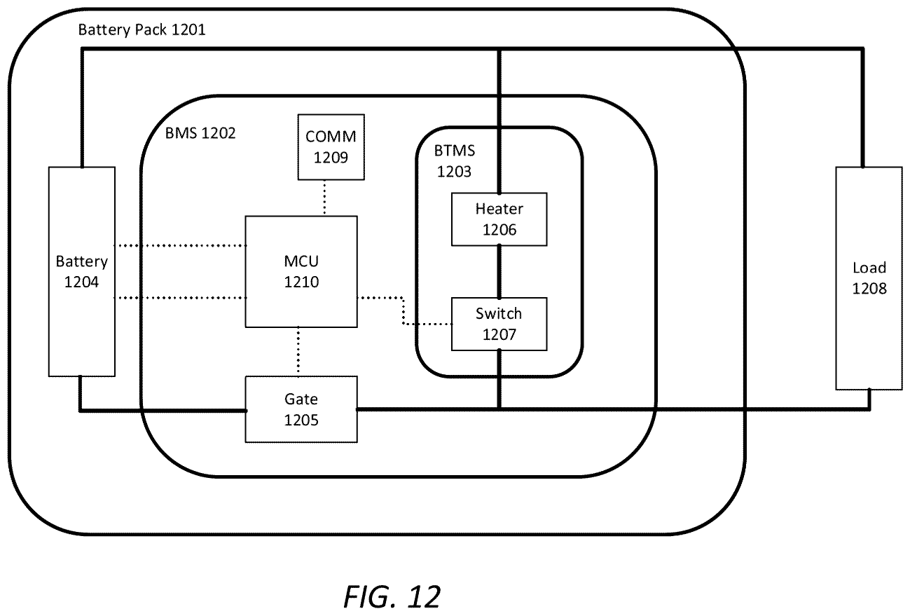

FIG. 12 is a representative view of the present design reflecting the battery pack 1201, BMS 1202, and BTMS 1203. Battery 1204, forming part of battery pack 1201, connects to the gate 105 of BMS 1202 as well as heater 1206 and load 1208. Gate 1205 and heater 1206 connect to switch 1207. and both the heater 1206 and switch 1206 connect to load 1208 in the manner shown. Communication module 1209 is shown as is master control unit, or MCU 1210. MCU 1210 receives relevant communications regarding temperature from communication module 1209. Present temperature and voltage are provided from battery 1204 to the MCU, which controls application of heat via switch 1207 by communicating with switch 1207 directly. MCU 1210 controls gate 1205 to allow or stop flow of current and/or voltage.

When engaged, switch 1207 switches heater 1206 on and off, providing or refraining from providing heat to battery 1204. In this manner, the temperature of the battery can be controlled based on the current temperature and voltage of the battery, based on external communications such as user programming.

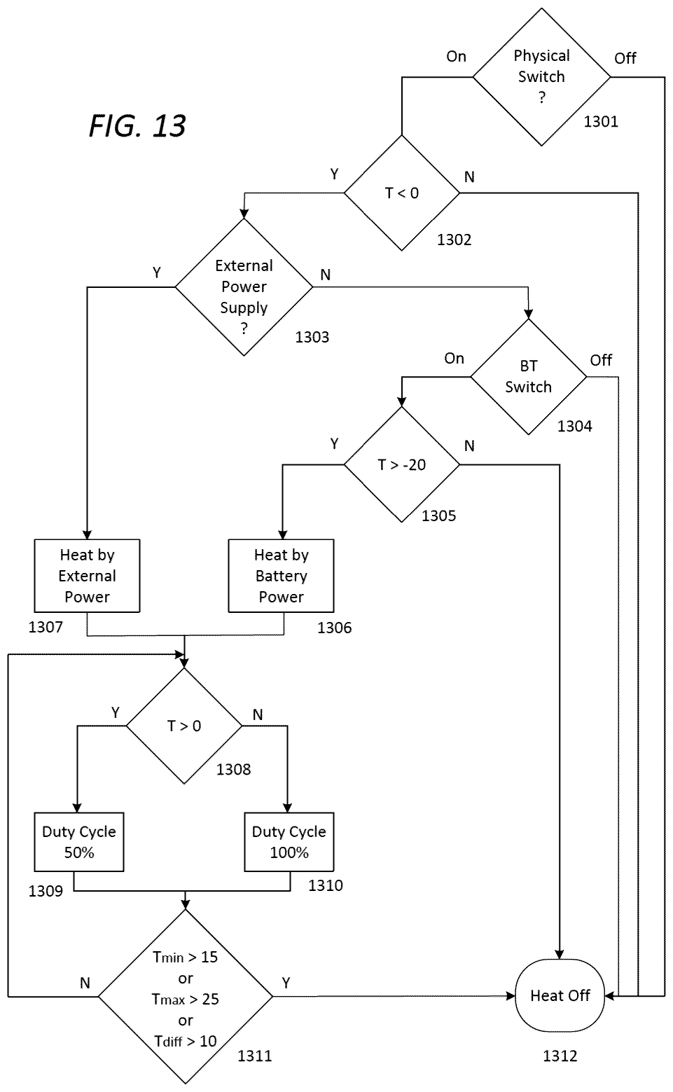

FIG. 13 is a general flowchart for operation of the BTMS, which may be executed in MCU 1210 of FIG. 12 or in any other component having appropriate processing functionality. From FIG. 13, the system initially determines whether a physical switch is on or off at point 1301. If off, the heater is turned off at point 1312. Otherwise, at point 1302, temperature is evaluated, and if less than zero degrees Celsius, or some other determined value, the system determines at point 1303 whether an external power supply is available. If the temperature is not less than zero degrees Celsius, or some other predetermined value, the heat is shut off if on at point 1312.

If no external power supply is available, point 1304 evaluates whether the BT (Bluetooth) or remote switch, shown as switch 1207 in FIG. 12, is on or off. If off, heat is turned off at point 1312, and if on, the system determines at point 1305 whether the temperature is greater than minus 20 degrees Celsius. As with all temperatures in FIG. 13, the values presented may be different depending on desired performance, and temperature values greater than or less than those identified may be employed. Additionally, other measures such as voltage may be assessed in addition to or as an alternative to temperature may be employed when determining heating functionality. Values assessed may not be limited to temperature and voltage but may include other relevant heat measurements including time, etc.

If the temperature is greater than minus 20 degrees Celsius in this embodiment, point 1306 calls for heating the arrangement using battery power, i.e., internally available power. If an external power supply is available based on the assessment at point 1303, point 1307 calls for heating by external power using the available external power supply, thereby saving internal power. Point 1308 then determines whether the temperature is greater than zero degrees Celsius in this embodiment. If the temperature is not above zero degrees Celsius in this embodiment, point 1310 calls for running the heating duty cycle at 100 percent. If the temperature is above zero degrees Celsius, the system operates heating at a 50 percent duty cycle at point 1309. Temperature below zero is considered a critical issue and thus operation at 100 percent duty cycle is warranted. Again, different values may be employed and different variables may be assessed, but in general, cold weather requires a level of heating greater than heating at warmer temperatures.

Once duty cycle has been set, the system determines whether temperature has changed in this embodiment. Point 1311 determines whether the minimum temperature is greater than 15 degrees Celsius, or the maximum temperature is greater than 25 degrees Celsius, or the difference between maximum and minimum is more than 10 degrees Celsius. If any of those conditions occurs, the heat is turned off at point 1312, but if not, duty cycle may be changed depending on current temperature.

Thus in this manner, the system operates by evaluating switch settings, assesses temperature in this embodiment and whether an external power supply is present, and implements heating conditions and duty cycle depending on current temperature state until an exit or stop condition occurs. In this manner, the system can accurately and adequately heat the battery arrangement to provide beneficial thermal conditions and adequate battery power.

Thus according to one embodiment, there is provided a battery arrangement comprising a plurality of generally cylindrical battery cells positioned side by side in a planar array, the plurality of generally cylindrical battery cells comprising at least 16 generally cylindrical battery cells and a battery thermal management system (BTMS) configured to evaluate switch conditions, temperature, and available equipment to effectuate a heating regimen for heating the generally cylindrical battery cells. The plurality of generally cylindrical battery cells is connected to provide electric power over a single electrical power transmission channel.

According to a further embodiment, there is provided a battery arrangement comprising a co-planar array of a plurality of substantially cylindrical battery cells in a single planar layer without a second planar layer of substantially cylindrical battery cells, wherein the plurality of substantially cylindrical battery cells comprises at least 16 substantially cylindrical battery cells, and a battery thermal management system (BTMS) configured to evaluate switch conditions, temperature, and available equipment to effectuate a heating regimen for heating the plurality of substantially cylindrical battery cells. The plurality of substantially cylindrical battery cells provides electric power over a single electrical power transmission channel.

According to another embodiment, there is provided a battery arrangement comprising a plurality of not less than sixteen substantially cylindrical battery cells arranged in a planar side by side orientation and a battery thermal management system (BTMS) configured to evaluate switch conditions, temperature, and available equipment to effectuate a heating regimen for heating the plurality of substantially cylindrical battery cells. The plurality of substantially cylindrical battery cells provides electric power over a single electrical power transmission channel.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A battery arrangement comprising:
a plurality of generally cylindrical battery cells positioned side by side in a planar array, the plurality of generally cylindrical battery cells comprising at least 16 generally cylindrical battery cells; and
a battery thermal management system (BTMS) configured to evaluate switch conditions, temperature, and available equipment to effectuate a heating regimen for heating the generally cylindrical battery cells;
wherein the plurality of generally cylindrical battery cells is connected to provide electric power over a single electrical power transmission channel.

2. The battery arrangement of claim 1, further comprising:
an upper layer of PTC heating film (PTCHF) adjoining upper ends of the plurality of generally cylindrical battery cells and a lower layer of PTCHF adjoining lower ends of the plurality of generally cylindrical battery cells.

3. The battery arrangement of claim 2, further comprising an external case maintaining the plurality of generally cylindrical battery cells, wherein when operating the plurality of generally cylindrical battery cells and the external case have no cables connected thereto.

4. The battery arrangement of claim 1, wherein the BTMS is configured to raise the temperature of the plurality of generally cylindrical battery cells in accordance with predetermined duty cycles operating based on temperature.

5. The battery arrangement of claim 1, further comprising a plurality of switches configured to enable turning the battery arrangement on and off.

6. The battery arrangement of claim 1, further comprising at least one of an inverter, a battery charger, and a battery monitor.

7. The battery arrangement of claim 5, wherein the battery monitor measures at least one of voltage, current, power, state of charge, temperature, and warning conditions.

8. A battery arrangement comprising:
a co-planar array of a plurality of substantially cylindrical battery cells in a single planar layer without a second planar layer of substantially cylindrical battery cells, wherein the plurality of substantially cylindrical battery cells comprises at least 16 substantially cylindrical battery cells; and
a battery thermal management system (BTMS) configured to evaluate switch conditions, temperature, and available equipment to effectuate a heating regimen for heating the plurality of substantially cylindrical battery cells;
wherein the plurality of substantially cylindrical battery cells provides electric power over a single electrical power transmission channel.

9. The battery arrangement of claim 1, further comprising:
a lower layer of PTC heating film (PTCHF) electrically connected to bases of all of the plurality of substantially cylindrical battery cells; and
an upper layer of PTCHF electrically connected to tops of all of the plurality of substantially cylindrical battery cells.

10. The battery arrangement of claim 9, further comprising an external case maintaining the plurality of substantially cylindrical battery cells, wherein when operation of the plurality of substantially cylindrical battery cells and the external case comprise no cables connected thereto.

11. The battery arrangement of claim 9, wherein the BTMS is configured to raise the temperature of the plurality of substantially cylindrical battery cells by passing warm gas upward through channels formed by the plurality of substantially cylindrical battery cells.

12. The battery arrangement of claim 8, further comprising a plurality of switches configured to enable turning the battery arrangement on and off.

13. The battery arrangement of claim 8, further comprising at least one of an inverter, a battery charger, and a battery monitor.

14. The battery arrangement of claim 13, wherein the battery monitor when available measures at least one of voltage, current, power, state of charge, and warning conditions.

15. A battery arrangement comprising:
a plurality of not less than sixteen substantially cylindrical battery cells arranged in a planar side by side orientation; and
a battery thermal management system (BTMS) configured to evaluate switch conditions, temperature, and available equipment to effectuate a heating regimen for heating the plurality of substantially cylindrical battery cells;
wherein the plurality of substantially cylindrical battery cells provides electric power over a single electrical power transmission channel.

16. The battery arrangement of claim 15, further comprising:
a conductive lower layer positioned below the plurality of substantially cylindrical battery cells; and
a conductive upper layer positioned atop the plurality of substantially cylindrical battery cells.

17. The battery arrangement of claim 16, wherein the conductive lower layer and the conductive upper layer comprise PTC heating film (PTCHF).

18. The battery arrangement of claim 15, wherein the BTMS is configured to raise the temperature of the plurality of substantially cylindrical battery cells in accordance with predetermined duty cycles operating based on temperature.

19. The battery arrangement of claim 16, further comprising a plurality of switches configured to enable turning the battery arrangement on and off.

20. The battery arrangement of claim 16, further comprising an external case maintaining the plurality of substantially cylindrical battery cells, wherein when operation of the plurality of substantially cylindrical battery cells and the external case comprise no cables connected thereto.
